(19) United States
(12) Patent Application Publication
(10) Pub. No.: US 2026/0341288 A1
(43) Pub. Date: Oct. 29, 2026

(54) SYSTEMS AND METHODS FOR PREDICTIVE SPATIAL AUDIO RENDERING

(71) Applicant: Varjo Technologies Oy, Helsinki (FI)

(72) Inventors: Mika-Petteri Lundgren, Salo (FI); Ville Timonen, Helsinki (FI); Oliver Merilaid, Helsinki (FI)

(73) Assignee: Varjo Technologies Oy, Helsinki (FI)

(21) Appl. No.: 19/186,897

(22) Filed: Apr. 23, 2025

(51) Int. Cl. G10L 19/04; H04S 7/00

(52) U.S. Cl. CPC G10L 19/04; H04S 7/304; H04S 2420/03

(57) ABSTRACT

Disclosed is a system for predictive spatial audio rendering, the system including: a head-mounted display (HMD) device and processor(s). The HMD device includes pose sensor(s). The processor(s) is configured to: receive a sensor data from the pose sensor(s) of the HMD device, the sensor data is indicative of a current pose of the HMD device at a first time instant; generate a predicted pose data of the HMD device corresponding to a second time instant subsequent to the first time instant; predictively render a spatial audio data to a binaural audio format corresponding to the second time instant, for playback at audio rendering device(s) of the HMD device; and transmit the spatial audio data in the binaural audio format, for playback, to the audio rendering device(s) of the HMD device.

### TECHNICAL FIELD

The present disclosure relates to systems for predictive spatial audio rendering. Moreover, the present disclosure relates to methods for predictive spatial audio rendering. Furthermore, the present disclosure relates to systems for predictive spatial audio rendering in head-mounted display (HMD) devices. Furthermore, the present disclosure relates to methods for predictive spatial audio rendering in HMD devices. Furthermore, the present disclosure relates to systems for spatial audio correction in HMD devices. Furthermore, the present disclosure relates to methods for spatial audio correction in HMD devices.

### BACKGROUND

In immersive environments such as virtual reality (VR), augmented reality (AR), and similar, spatial audio rendering plays an essential role in enhancing perception of a user by simulating real-world sound localization. The spatial audio ensures that sounds appear to originate from specific locations relative to the user's head position and movements, creating a realistic and immersive auditory experience. However, due to inherent latencies in audio processing and rendering, the spatial audio often lags behind real-time head movements of the user, leading to a misalignment between auditory and visual cues. This discrepancy diminishes realism of the spatial audio and can cause disorientation or discomfort for the user, particularly in fast-paced VR/AR applications.

Conventionally, spatial audio systems render the spatial audio based on past or current head-tracking data, without accounting for future pose changes. Some existing VR and AR systems implement pose prediction techniques for video rendering to compensate for motion latency, ensuring that visual content aligns with real-world head movements. These techniques estimate the user's future head position based on current movement trends, allowing the visual content to be adjusted in advance and preventing motion lag in display systems. Additionally, some existing systems may employ late-stage prediction and warping methods in their compositors to refine a visual output as close to real-time as possible. These solutions significantly improve visual accuracy and reduce perceptual disconnect between head motion and rendered images. Despite these advancements in video prediction techniques, existing spatial audio rendering systems do not incorporate pose prediction to pre-emptively adjust an audio output. In conventional systems, the spatial audio is typically rendered based on previously head position and transmitted in a processed format, without real-time corrections. This approach may introduce latency, as the spatial audio lags behind, causing a noticeable desynchronization between auditory and visual elements. Thus, the absence of a late-stage correction mechanism for the spatial audio introduces a fundamental limitation in existing VR/AR systems.

Therefore, in light of the foregoing discussion, there exists a need to overcome the aforementioned drawbacks.

### SUMMARY

The aim of the present disclosure is to provide a system and a method for predictive spatial audio rendering that enables real-time adjustment of spatial audio data based on head movements of a user in real-time, thereby ensuring an accurate spatial alignment of audio sources and enhancing immersive auditory experience in a head-mounted display (HMD) device. The aim of the present disclosure is achieved by a system and a method for predictive spatial audio rendering, as defined in the appended independent claims to which reference is made to. The aim of the present disclosure is to provide a system and a method for predictive spatial audio rendering in a HMD device that processes the spatial audio data based on real-time pose tracking, and ensures precise auditory localization in response to head movements of the user, thereby enhancing spatial accuracy and synchronization between auditory and visual stimuli. The aim of the present disclosure is achieved by a system and a method for predictive spatial audio rendering in a HMD device, as defined in the appended independent claims to which reference is made to. The aim of the present disclosure is to provide a system and a method for spatial audio correction in a HMD device that facilitates dynamic adjustment of the spatial audio data based on real-time pose data, enabling precise auditory localization and minimizing perceptual discrepancies between audio and visual stimuli. The aim of the present disclosure is achieved by a system and a method for spatial audio correction in a HMD device, as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates a block diagram of a system for predictive spatial audio rendering, in accordance with a first aspect of the present disclosure;

FIG. 2 illustrates steps of a method for predictive spatial audio rendering, in accordance with a second aspect of the present disclosure;

FIG. 3 illustrates a block diagram of a system for predictive spatial audio rendering in a head-mounted display (HMD) device, in accordance with a third aspect of the present disclosure;

FIG. 4 illustrates steps of a method for predictive spatial audio rendering in a HMD device, in accordance with a fourth aspect of the present disclosure;

FIG. 5 illustrates a block diagram of a system for spatial audio correction in a HMD device, in accordance with a fifth aspect of the present disclosure; and

FIG. 6 illustrates steps of a method for spatial audio correction in a HMD device, in accordance with a sixth aspect of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides a system for predictive spatial audio rendering, the system comprising:
a head-mounted display (HMD) device comprising at least one pose sensor; and
at least one processor configured to:
   receive a sensor data from the at least one pose sensor of the HMD device, wherein the sensor data is indicative of a current pose of the HMD device at a first time instant;
   generate a predicted pose data of the HMD device corresponding to a second time instant subsequent to the first time instant, based on the sensor data;
   predictively render a spatial audio data to a binaural audio format corresponding to the second time instant, for playback at at least one audio rendering device of the HMD device, based on the predicted pose data of the HMD device; and
   transmit the spatial audio data in the binaural audio format, for playback, to the at least one audio rendering device of the HMD device.

In a second aspect, the present disclosure provides a method for predictive spatial audio rendering, the method comprising:
receiving a sensor data from at least one pose sensor of a head-mounted display (HMD) device, wherein the sensor data is indicative of a current pose of the HMD device at a first time instant;
generating a predicted pose data of the HMD device corresponding to a second time instant subsequent to the first time instant, based on the sensor data;
predictively rendering a spatial audio data to a binaural audio format corresponding to the second time instant, for playback at at least one audio rendering device of the HMD device, based on the predicted pose data of the HMD device; and
transmitting the spatial audio data in the binaural audio format, for playback, to the at least one audio rendering device of the HMD device.

The present disclosure provides the aforementioned first aspect and the aforementioned second aspect for predictive spatial audio rendering. It will be appreciated that the system for predictive spatial audio rendering enhances accuracy and responsiveness of the spatial audio data for playback in the head-mounted display (HMD) device. By generating the predicted pose data corresponding to the second time instant (i.e., a future time instant), the spatial audio data can be pre-rendered in the binaural format, thereby reducing perceptible latency and improving synchronization between audio output and head movement. This is particularly beneficial in virtual reality (VR), augmented reality (AR), extended reality (XR), and mixed reality (MR) applications, where precise spatial audio alignment enhances user immersion and realism. Beneficially, the transmission of pre-rendered spatial audio data ensures that the system can efficiently process and deliver spatialized sound with minimal delay. Notably, the first aspect enhances accuracy, responsiveness, and synchronization of spatial audio playback by generating the predicted pose data and pre-rendering spatial audio in the binaural format. Such predictive approach mitigates perceptible latency and reduces reliance on real-time computational adjustments, thereby minimizing processing latency of the system. Moreover, the method for predictive spatial audio rendering ensures that the spatial audio data is computed based on the predicted pose data before being transmitted for playback. This predictive approach minimizes need for real-time computational adjustments, thereby reducing processing latency and improving efficiency of the system. It will be appreciated that by pre-emptively adjusting the spatial audio data to align with an anticipated (namely, an expected) head movement of the user, the method enables smoother and more natural audio transitions, mitigating a perception of lag or misalignment in spatial sound localization. It will further be appreciated that the system enables a last-moment correction of the spatial audio data by comparing the latest pose data at playback time with the predicted pose data. This correction process ensures that even slight deviations between predicted head orientation and actual head orientation are compensated for just before audio playback. As a result, auditory scene remains correctly aligned with the user's real-time head movement, thereby enhancing spatial audio precision and minimizing perceptual inconsistencies. The system and the method are fast, robust, easy to implement, and facilitate accurate predictive spatial audio rendering by pre-generating the binaural audio format based on the anticipated head movement, thereby minimizing latency and improving synchronization.

Throughout the present disclosure, the term “predictive spatial audio rendering” refers to a technique for processing and generating the spatial audio data in which an audio output is rendered in advance based on predicted future head movements of a user. Such an approach utilizes real-time pose tracking data from the HMD device to estimate future head position of the user at the second time instant. The at least one processor then pre-renders the spatial audio data corresponding to the predicted pose data to minimize latency and improve synchronization between the spatial audio data and the user's actual head movements.

Throughout the present disclosure, the term “head-mounted display device” refers to a specialized equipment that is configured to present an extended reality (XR) environment to a user when said HMD, in operation, is worn by the user on their head. The HMD is implemented, for example, as an XR headset, a pair of XR glasses, and the like, that is operable to display a visual scene of the XR environment to the user. It will be appreciated that when a given device is the HMD, it enables immersive user experiences by directly engaging in the user's field of view, allowing for seamless integration of virtual or augmented content with the physical world, improving interaction and immersion of the user. Moreover, the term “extended-reality headset” refers to a wearable device designed to immerse the user in the XR environment. The term “extended-reality” encompasses VR, AR, mixed reality (MR), and the like. The term “pose sensor” refers to a sensor configured to detect and provide a data indicative of a position, an orientation, a movement or similar, of the HMD device in a given space (i.e., a three-dimensional (3D) space and a two-dimensional (2D) space). Herein, the term “given space” refers to a physical environment where the spatial audio data is being captured. Thereafter, the spatial audio data that is captured in the physical environment is rendered to a virtual environment, wherein the virtual environment is a digital representation of the physical environment. The physical environment is a real-world environment. The virtual environment could, for example, be an XR environment. The given space can be of any shape, size, or configuration and could include an indoor environment (for example, such as a room, a hall, and similar), an outdoor environment, and similar. The at least one sensor generates pose data, which may include parameters such as spatial coordinates, an angular orientation, a velocity, an acceleration, and similar. Herein, the at least one pose sensor continuously measures the position and/or orientation of the HMD device and transmits this data to the at least one processor for further processing (as described later). The at least one pose sensor may be implemented using one or more sensing technologies, for example, such as inertial measurement units (IMUs), accelerometers, gyroscopes, magnetometers, optical tracking systems, depth sensors, and similar. It will be appreciated that integrating the at least one pose sensor in the HMD device enables precise spatial tracking, which is essential for maintaining accurate XR experiences. By continuously updating a pose data, the system ensures real-time alignment of virtual content with the user's head movements, reducing latency and improving spatial accuracy, thereby enhancing the user comfort and interaction precision.

Throughout the present disclosure, the term “processor” refers to a computational element that is operable to execute the software framework. Examples of the processor may include, but are not limited to, a microprocessor, a microcontroller, a complex instruction set computing (CISC) microprocessor, a reduced instruction set computing (RISC) microprocessor, a very long instruction word (VLIW) microprocessor, digital signal processor (DSP), central processing unit (CPU), Field Programmable Gate Array (FPGA), or any other type of processing circuit. In an implementation, the at least one processor is communicably coupled to the HMD device. The at least one processor controls an overall operation for predictive spatial audio rendering of the aforementioned first aspect.

Throughout the present disclosure, the term “sensor data” refers to an information generated by the at least one pose sensor of the HMD device, representing measurements related to a position, an orientation, a motion, or other spatial characteristics of the HMD device. The sensor data may include parameters such as spatial coordinates, an angular orientation, a velocity, an acceleration, a rotational data, and similar. Herein, the sensor data is continuously transmitted to the at least one processor for real-time processing and the predictive spatial audio rendering. The term “current pose” refers to a spatial state of the HMD device at a given moment, defined by its position and orientation in a 3D coordinate system. The current pose may be expressed in terms of absolute or relative coordinates, including translational and rotational components. The current pose (i.e., a position and an orientation) is determined based on the sensor data acquired from the at least one pose sensor of the HMD device and serves as a reference for tracking movements and rendering spatial audio accordingly. It will be appreciated that although the term “pose” as used herein may refer to both position and orientation of the HMD device (i.e., 6 DoF), the correction techniques described in the present disclosure are primarily directed toward rotational correction, i.e., correcting orientation (yaw, pitch, and roll) corresponding to three degrees of freedom (3 DoF). In other words, the disclosed system compensates for head rotations, and does not correct for translational changes in position. The term “first time instant” refers to a specific moment in time at which the current pose of the HMD device is determined. The first time instant is used as a baseline for the predictive spatial audio rendering, enabling the system to generate the predicted pose for the second time instant. Herein, the at least one processor is configured to receive the sensor data from the at least one pose sensor integrated into the HMD device. The at least one pose sensor may utilize various sensing technologies, such as the IMUs, accelerometers, gyroscopes, optical tracking systems, and similar, to detect real-time changes in position and orientation. The at least one processor is then configured to process the sensor data to determine the current pose of the HMD device at the first time instant. It will be appreciated that by acquiring precise pose data at the first time instant, the system enables real-time and the predictive spatial audio rendering. Such an approach minimizes latency and ensures that audio cues remain spatially accurate relative to the user's head movements. As a result, the system improves spatial audio localization, enhances immersion, and maintains seamless synchronization between audio and visual elements in the XR environment.

Throughout the present disclosure, the term “predicted pose data” refers to an estimated spatial state of the HMD device at a future moment in time, derived based on previously acquired sensor data. The predicted pose data represents a forecasted position and orientation of the HMD device in the 3D coordinate system at the second time instant. The predicted pose data may include translational and rotational parameters, such as the spatial coordinates, the angular orientation, the velocity, the acceleration, and similar. The term “second time instant” refers to a specific point in a given time occurring after the first time instant, at which the predicted pose data of the HMD device is determined. The second time instant represents a future time instant for which the at least one processor estimates spatial state of the HMD device based on the sensor data. Herein, the at least one processor is configured to process the sensor data obtained at the first time instant, which may include position, orientation, velocity, acceleration, and similar. In this regard, using predictive algorithms, for example, such as motion prediction models, machine learning techniques, kinematic estimation methods, and similar, the at least one processor generates the predicted pose data corresponding to the second time instant based on the sensor data. This prediction accounts for ongoing motion patterns to estimate where the HMD device will be at the second time instant. It will be appreciated that by generating the predicted pose data for the second time instant, the system enhances an accuracy of the predictive spatial audio rendering, ensuring that audio cues remain aligned with the user's movements in real-time. This predictive approach minimizes processing delays, improves synchronization between visual and auditory elements, and enhances the user's immersive experience in the XR environment. Additionally, such an approach minimizes deviations between estimated and actual spatial state of the HMD device, resulting in a smoother and more precise user interactions while enhancing overall responsiveness of the system.

Throughout the present disclosure, the term “spatial audio data” refers to an information set representing audio signals that is processed to simulate spatial characteristics, such as directionality, distance, and environmental acoustics, relative to the user's position and orientation in the given space. The spatial audio data may encode parameters such as interaural time differences (ITD), interaural level differences (ILD), Head-Related Transfer Function (HRTF), reverberation effects, and similar auditory cues. The spatial audio data is utilized to create an immersive audio experience by rendering the spatial audio data that dynamically adapt based on movement and orientation of the user's head. The term “binaural audio format” refers to an audio representation designed to replicate a way audio is naturally heard by human ears, providing 3D audio experience. In this format, two audio channels (i.e., left and right) are used to simulate how audio would reach each ear from different directions and distances. The binaural audio format incorporates factors such as timing, intensity, and frequency modifications caused by a shape of an outer ear (i.e., pinna), head, and torso, which affect how audio is perceived from various spatial positions. The binaural audio format allows direct playback at the HMD device. The term “audio rendering device” refers to a device within the HMD device that is configured to process and output audio signals based on the spatial audio data. Examples of the at least one audio rendering device may include, but are not limited to, an integrated speaker, an earbud, and an external headphone that convert the spatial audio data into audible sound. Additionally, the at least one audio rendering device may incorporate signal processing units responsible for real-time spatial audio adjustments, ensuring accurate synchronization with the user's movements within the XR environment.

Herein, the at least one processor is configured to receive the predicted pose data corresponding to the second time instant, which has been derived from the sensor data obtained at the first time instant. Based on the predicted pose data, the at least one processor may determine an anticipated auditory scene at the second time instant. Once the spatial audio data has been transformed according to the predicted pose data, the at least one processor may encode the spatial audio data into the binaural audio format. The spatial audio data may originate from a variety of formats, including but not limited to multichannel formats, object-based audio, Ambisonic formats, and a combination thereof. For example, spatial audio systems such as Moving Picture Experts Groups-High Efficiency (MPEG-H) 3D Audio can integrate multiple spatial audio formats to provide an enhanced and flexible auditory experience. The binaural rendering process converts the spatial audio data into a stereo signal that preserves perceived direction and depth of sound. This process maintains spatial accuracy during playback, ensuring that the sound appears to come from correct direction relative to the user's head orientation. To support this, low-latency signal processing may be applied to minimize any mismatch between visual and auditory cues, thereby improving overall immersive experience. The processed binaural audio format corresponding to the second time instant is then rendered at the at least one audio rendering device of the HMD device for playback. In this regard, the playback occurs in synchronization with the second time instant, ensuring that the binaural audio format which is being rendered matches the anticipated head movement of the user, thereby minimizing perceptual discrepancies between visual and auditory cues. A technical effect of predictively rendering the spatial audio data to the binaural audio format is that it reduces audio processing latency and enhances spatial alignment of sound cues with the anticipated head movement of the user. Such an approach improves perceptual accuracy and ensures precise synchronization between auditory and visual stimuli, thereby enhancing immersion and interaction fidelity in the XR environment.

Optionally, the at least one audio rendering device comprises at least one of: an integrated stereo speaker, a headphone, an audio headset. In this regard, the term “integrated stereo speaker” refers to a speaker assembly that is built into the HMD device and configured to output stereo audio signals. The integrated stereo speaker comprises at least two speaker drivers positioned to deliver the spatialized sound directly to the user without requiring external audio peripherals. The term “stereo speaker” refers to a speaker system that includes two separate audio channels, typically a left channel and a right channel, designed to reproduce sound with spatial separation between audio signals delivered to each ear. The integrated stereo speaker emulates headphone-based systems in the HMDs, wherein spatial perception is further enabled through spatial audio rendering techniques. Moreover, the term “headphone” refers to an audio playback device configured to be worn over the user's ears to deliver the binaural audio format. The headphone comprises at least two speaker drivers (i.e., one for each ear) allowing precise reproduction of the spatial audio data. The headphone may be wired or wireless and may include additional components such as noise isolation to enhance audio clarity. Moreover, the term “audio headset” refers to a wearable audio device configured to provide the binaural audio format for playback while optionally incorporating additional functionalities such as a built-in microphone, communication interface, augmented sound processing features, and similar. The audio headset comprises at least one pair of earphones or speakers that deliver stereo or spatialized sound, typically enclosed in an ergonomic form factor designed for extended wear. The aforesaid types of the at least one audio rendering device are well-known in the art.

A technical effect of the at least one audio rendering device comprising at least one of: the integrated stereo speaker, the headphone, the audio headset is that it enables adaptable spatial audio rendering across different playback configurations, ensuring optimized spatial sound reproduction while maintaining perceptual consistency and synchronization with the user's anticipated head movements in various usage scenarios.

Next, in the first aspect, the at least one processor is then configured to transmit the binaural audio format, for playback, through an appropriate transmission channel, which may include a wired interface (e.g., direct electrical connection via audio jack, Universal Series Bus (USB), proprietary connector, and the like), a wireless interface (e.g., Bluetooth, Wireless Fidelity (Wi-Fi), proprietary low-latency audio streaming protocols, and the like), and similar. In this regard, the at least one processor ensures low-latency transmission to prevent perceptual mismatches between visual and auditory stimuli. A technical effect of transmitting the spatial audio data in the binaural audio format, for playback, at the at least one audio rendering device is that it enables consistent and perceptually accurate spatial audio experiences across different output devices while maintaining real-time synchronization with the user's head movements. Such an approach enhances auditory spatial localization, reduces perceptual discrepancies between audio and visual cues, and improves overall immersion in the XR environment.

Optionally, the HMD device further comprises an audio processing unit, wherein when the spatial audio data is predictively rendered to a spatial audio format, the at least one processor is further configured to transmit the spatial audio data to the audio processing unit,

wherein the audio processing unit is configured to:
obtain the spatial audio data in the spatial audio format;
obtain latest pose data from the at least one pose sensor of the HMD device, wherein the latest pose data is indicative of a current pose of the HMD device at the second time instant;
determine a pose difference between the latest pose data and the predicted pose data;
apply a rotational correction to the spatial audio data, based on the pose difference, to generate a corrected spatial audio data;
render the corrected spatial audio data to the binaural audio format; and
transmit the spatial audio data in the binaural audio format, for playback, to the at least one audio rendering device of the HMD device.

In this regard, the term “audio processing unit” refers to a hardware or a software module within the HMD device that manipulates audio signals, enhancing their quality, adding effect and/or transforming their characteristics. Optionally, in some implementations, the audio processing unit may not be within the HMD device. Moreover, the term “spatial audio format” refers to an intermediate representation of audio data where the sound sources are encoded with spatial metadata, defining their position relative to the user in the given space. The spatial audio format supports predictive rendering of sound before final binaural processing and may include Ambisonics formats, object-based spatial audio, multichannel formats, and similar. The spatial audio format allows for real-time adjustments, such as rotational corrections, to ensure accurate auditory spatialization in relation to the user's actual head movements. Moreover, the term “latest pose data” refers to real-time tracking information obtained from the at least one pose sensor of the HMD device, representing the current pose of the HMD device at the second time instant. The latest pose data may include parameters such as a head position, an orientation (e.g., a yaw, a pitch, a roll, and the like), a velocity, an acceleration, and similar. The latest pose data may be used to determine deviations from previously predicted pose data, enabling rotational corrections to be applied to the spatial audio data to maintain alignment with the user's actual head movements. Moreover, the term “rotational correction” refers to a computational transformation applied to the spatial audio data to account for discrepancies between the predicted pose data and the latest pose data. Herein, the rotational correction is limited to correcting orientation of the HMD device in 3 DoF, namely yaw, pitch, and roll. The rotational correction modifies the spatial positioning of the sound sources based on real-time head movements of the user, ensuring that the sound remains perceptually fixed in the given space relative to the user's head. This correction prevents misalignment between auditory and visual cues, enhancing spatial accuracy of the rendered binaural audio format. Examples of the sound sources may include, but are not limited to, a human voice, a musical instrument, an environmental sound, a sound effect in games or movies, a footstep, and a machine sound.

Herein, the audio processing unit obtains the spatial audio data that has been pre-rendered into the spatial audio format. It is to be understood that the spatial audio data has been generated by the at least one processor. Next, the audio processing unit obtains the latest pose data from the at least one pose sensor integrated into the HMD. The latest pose data corresponds to the current orientation and position of the HMD device at the second time instant. The latest pose data may be sourced from the IMU, optical tracking system, a combination of both, and similar, providing parameters such as a head orientation of a user (i.e., a yaw, a pitch and the like), a head position of a user (i.e., x, y, z coordinates in a 3D space), a velocity, an acceleration, and the like. Herein, the latest pose data may be obtained at a high refresh rate (e.g., 1000 Hertz or higher) to ensure real-time tracking accuracy.

Next, the audio processing unit compares the latest pose data with the predicted pose data that has been used when the spatial audio data has been initially pre-rendered. Herein, the pose difference may be calculated as a transformation matrix or a quaternion difference between the latest pose data (i.e., an actual head orientation of the user) and the predicted pose data (i.e., a predicted head orientation of the user). This difference may account for rotational deviations (i.e., a yaw, a pitch, roll changes and the like), which represent 3 DoF relevant to spatial audio correction. The pose difference is then used to determine how much correction needs to be applied to the spatial audio data to maintain perceptual alignment. In this regard, the audio processing unit applies the rotational correction to the spatial audio data to compensate for discrepancies between the latest pose data and the predicted pose data. Herein, the rotational correction may be performed using rotation matrices, quaternion transformations, vector recalculations, and similar, to shift perceived location of sound sources in the spatial audio format. The corrected spatial audio data maintains an intended spatial positioning, ensuring that fixed sound sources (e.g., a virtual speaker in an environment, and the like) may remain anchored in place, moving sound sources may retain their expected trajectories relative to the user's new head position, and similar. It will be appreciated that such a process prevents auditory spatial drift, which may otherwise lead to a misalignment between auditory and visual cues.

Next, the audio processing unit renders the corrected spatial audio data to the binaural audio format, ensuring perceptual accuracy in the headphones. The binaural rendering ensures that the user experiences 3D positional audio accurately aligned with their real-world head movements. Once rendered, the binaural audio format is then transmitted to the at least one audio rendering device of the HMD device for playback. Thus, the audio processing unit ensures real-time synchronization between visual and auditory stimuli, preventing perceptual lag or audio drift. It will be appreciated that the aforesaid process allows last-moment (namely, last-second) correction of the spatial audio data based on the user's real-time head movements, ensuring that auditory cues remain accurately aligned with visual elements. This prevents perceptual mismatches, enhances spatial audio precision, and improves overall immersion in the XR environment.

A technical effect of applying the rotational correction to the spatial audio data based on the difference between the latest pose data and the predicted pose data is that it ensures an accurate auditory spatialization, thereby enhancing an immersive experience the XR environment.

Optionally, the spatial audio format comprises at least one of: a first-order Ambisonics format, a higher-order Ambisonics format, a multi-channel audio format. In this regard, the term “first-order Ambisonics format” refers to a spherical spatial audio encoding method that represents sound fields using four channels, i.e., omnidirectional (W) and three directional components (X, Y, Z), corresponding to a Cartesian axes. The first-order Ambisonics format captures basic spatial information, allowing for full-sphere audio reproduction with a limited spatial resolution. The first-order Ambisonics format is commonly used in the VR, the AR, and the XR applications for real-time head-tracked audio rendering. Beneficially, the first-order Ambisonics format enables efficient spatial audio representation with a relatively low computational cost, making it suitable for applications requiring real-time processing while maintaining spatial accuracy. It will be appreciated that rendering the spatial audio data in the first-order Ambisonics format enables efficient real-time spatial audio processing while maintaining a full-sphere sound representation, allowing for dynamic head-tracked audio rendering in the VR, the AR, and the XR applications with minimal computational overhead.

Moreover, the “higher-order Ambisonics format” extends spatial resolution of the first-order Ambisonics format by incorporating additional spherical harmonics components beyond the four channels. Higher orders (e.g., second-order, third-order, and beyond) increase precision of spatial audio rendering, improving sound source localization and directional accuracy. The higher-order Ambisonics format is used in immersive audio systems, spatial audio recording, and high-fidelity XR environments where accurate 3D positioning of the sound sources is required. It will be appreciated that rendering the spatial audio data in the higher-order Ambisonics format enhances spatial resolution and directional accuracy, enabling precise localization of the sound sources in immersive environments, thereby improving auditory realism and the user immersion in XR applications.

Moreover, the term “multi-channel audio format” refers to an audio encoding method that distributes audio signals across multiple discrete channels for spatial playback. Examples of the multi-channel audio format may include, but are not limited to, 5.1 surround sound (i.e., six channels), 7.1 surround sound (i.e., eight channels), and custom spatial configurations for XR applications. Unlike Ambisonics, which represents a complete spherical sound field, the multi-channel audio format assign specific audio signals to predefined speaker positions, making them suitable for multi-speaker setups in gaming, cinema, VR, and similar. It will be appreciated that rendering the spatial audio data in the multi-channel audio format enables efficient distribution of spatialized audio signals across predefined speaker configurations, ensuring compatibility with surround sound systems and enhancing spatial audio experiences in gaming, cinema, XR applications, and similar.

A technical effect of the spatial audio format comprising at least one of: the first-order Ambisonics format, the higher-order Ambisonics format, the multi-channel audio format, is that it enables flexible and optimized spatial audio encoding for different playback environments, ensuring immersive and perceptually accurate 3D audio experiences. By supporting multiple spatial audio formats, the system maintains high-quality spatial audio rendering across various device configurations while reducing computational overhead where necessary.

Optionally, the at least one processor is further configured to:
generate a plurality of predicted pose data corresponding to different future time instants;
predictively render the spatial audio data for each of the plurality of predicted pose data; and
transmit each of the predictively rendered spatial audio data to the HMD device.

In this regard, the at least one processor is configured to generate the plurality of predicted pose data corresponding to different future time instants by leveraging motion prediction algorithms, sensor fusion techniques, and similar. Specifically, the at least one processor may utilize data from the IMU, optical tracking system, and the at least one pose sensor integrated within the HMD device to estimate an orientation and a position of the user's head over time. In this regard, by analysing historical pose data and applying predictive models such as Kalman filtering, machine learning-based motion forecasting, and similar, the at least one processor can accurately anticipate how the user's head will move at different future time instances. This enables the system to proactively account for head movements and prepare corresponding audio data in advance.

Next, the at least one processor is configured to predictively render the spatial audio data for each of the plurality of predicted pose data. For each predicted pose data, the at least one processor may apply spatial audio rendering techniques, such as Ambisonics, HRTFs, and similar, to generate audio signals that correspond to expected head position and orientation of the user. By pre-rendering the spatial audio data for various potential head poses, the at least one processor can accurately model perceived directionality and distance of the sound sources within a 3D environment. This allows the system to maintain an accuracy of the spatial audio data even when the user's head moves rapidly, thereby preventing auditory lag and ensuring a fully immersive audio experience. Then, the at least one processor is configured to transmit each of the predictively rendered spatial audio data to the HMD device. The at least one processor sends multiple pre-rendered audio frames to the HMD device in advance, allowing the audio processing unit of the HMD device to instantly select most accurate audio frame based on the user's actual head pose at a given moment. Such an approach eliminates need for real-time audio rendering during head movements, significantly reducing audio latency and preventing perceptual drift between visual and auditory cues. As a result, the system ensures seamless synchronization between spatial audio experience and the user's head movements in real-time XR environments.

A technical effect of the aforementioned feature is that it enables seamless spatial audio synchronization by generating the plurality of predicted pose data and pre-rendering corresponding spatial audio data, thereby allowing instant selection of the most accurate audio frame based on the user's actual head pose, and effectively minimizing audio lag.

Optionally, the HMD device further comprises the at least one audio rendering device. In this regard, the at least one audio rendering device receives the spatial audio data from the at least one processor, which has already predicted the user's future head poses and pre-rendered the corresponding audio signals. The at least one audio rendering device then accurately outputs the spatial audio signals in real time based on the user's actual head orientation. This allows for precise sound localization and seamless synchronization with visual content, enhancing the user's immersion in the virtual environment. In an implementation, the at least one audio rendering device is communicably coupled to the at least one processor. A technical effect of the HMD device further comprising the at least one audio rendering device is that it allows for real-time, low-latency spatial audio playback that dynamically adapts to the user's head movements, thereby ensuring an enhanced immersive audio experience in XR environments.

The present disclosure also relates to the aforementioned second aspect as described above. Various embodiments and variants disclosed above, with respect to the aforementioned first aspect, apply mutatis mutandis to the aforementioned second aspect.

In a third aspect, the present disclosure provides a system for predictive spatial audio rendering in a head-mounted display (HMD) device, the system comprising:

the HMD device comprising:
at least one pose sensor; and
an audio processing unit; and
   at least one processor that is configured to:
receive a sensor data from at least one pose sensor of the HMD device, wherein the sensor data is indicative of a current pose of the HMD device at a first time instant;
generate a predicted pose data of the HMD device corresponding to a second time instant subsequent to the first time instant, based on the sensor data;
predictively render a spatial audio data for the second time instant to a spatial audio format corresponding to the second time instant, to the audio processing unit of the HMD device, based on the predicted pose data; and
transmit the spatial audio data to the audio processing unit of the HMD device,
   wherein the audio processing unit is configured to:
obtain latest pose data from the at least one pose sensor of the HMD device, wherein the latest pose data is indicative of a current pose of the HMD device at the second time instant;
determine a pose difference between the latest pose data and the predicted pose data;
apply a rotational correction to the spatial audio data, based on the pose difference;
convert the spatial audio data from the spatial audio format to a binaural audio format; and
perform at least one of:
   transmitting the spatial audio data in the binaural audio format, for playback, to at least one audio rendering device of the HMD device;
   processing the spatial audio data in the binaural audio format for playback, without transmission.

In a fourth aspect, the present disclosure provides a method for predictive spatial audio rendering in a head-mounted display (HMD) device, the method comprising:
receiving a sensor data from at least one pose sensor of the HMD device, wherein the sensor data is indicative of a current pose of the HMD device at a first time instant;
generating a predicted pose data of the HMD device corresponding to a second time instant subsequent to the first time instant, based on the sensor data;
predictively rendering a spatial audio data for the second time instant to a spatial audio format corresponding to the second time instant, to the audio processing unit of the HMD device, based on the predicted pose data; and
transmitting the spatial audio data to an audio processing unit of the HMD device,
obtaining latest pose data from the at least one pose sensor of the HMD device, wherein the latest pose data is indicative of a current pose of the HMD device at the second time instant;
determining a pose difference between the latest pose data and the predicted pose data;
applying a rotational correction to the spatial audio data, based on the pose difference;
converting the spatial audio data from the spatial audio format to a binaural audio format; and
performing at least one of:
   transmitting the spatial audio data in the binaural audio format, for playback, to at least one audio rendering device of the HMD device;
   processing the spatial audio data in the binaural audio format for playback, without transmission.

The present disclosure provides the aforementioned third aspect and the aforementioned fourth aspect for predictive spatial audio rendering in the HMD device. It will be appreciated that the system and the method for predictive spatial audio rendering enhance accuracy, responsiveness, and synchronization of the spatial audio data for playback in real-time applications. By generating the predicted pose data corresponding to the second time instant, the spatial audio data can be pre-rendered in the spatial audio format, thereby mitigating perceptible latency and improving alignment between audio output and head movement. In this regard, the predictive approach reduces reliance on real-time computational adjustments, thereby minimizing processing latency and improving efficiency of the system. Moreover, an incorporation of the audio processing unit allows for an efficient separation of the predictive rendering and real-time correction, thereby optimizing processing load distribution between the at least one processor and the audio processing unit. This configuration ensures that any deviation between the predicted and actual head position is compensated for in real time, improving spatial audio fidelity and enhancing user immersion. The transmission of the spatial audio data to the audio processing unit ensures that the system can efficiently deliver the spatialized sound with minimal delay, thereby enhancing the user immersion in VR/AR environments and similar. It will be appreciated that transmitting the spatial audio data to the audio processing unit improves an accuracy and perceptual coherence of the spatial audio data by mitigating discrepancies between predicted and actual head movement.

Moreover, the audio processing unit obtains the latest pose data at the second time instant and determines the pose difference relative to the predicted pose data. Such an approach enables real-time error correction by applying the rotational correction to the spatial audio data, thereby ensuring that the spatial audio data remains accurately aligned with the user's actual head position. This is particularly advantageous in dynamic environments where unpredictable head movements could otherwise introduce perceptual inconsistencies. Moreover, by converting the spatial audio data from the spatial audio format to the binaural audio format at the audio processing unit, allows the spatialized sound to retain its intended three-dimensional characteristics, thereby enhancing the user immersion in VR, AR applications, and similar. Notably, the third aspect improves spatial audio fidelity by incorporating real-time correction. By utilizing the audio processing unit, the third aspect compensates for deviations between the predicted and actual head positions, ensuring precise alignment of the spatial audio data with head movements of the user.

The system and the method provides flexibility in audio playback by performing the at least one of: transmitting the spatial audio data in the binaural audio format, for playback, to the at least one audio rendering device of the HMD device; and processing the spatial audio data in the binaural audio format for playback, without transmission. Such an approach ensures adaptability to different hardware architectures, allowing seamless integration with various processing pipelines while maintaining low-latency audio synchronization. The system and the method are fast, robust, easy to implement, and facilitate accurate predictive spatial audio rendering with real-time correction, ensuring precise alignment between spatial audio output and actual head movement.

In the third aspect, the system is specifically designed to perform spatial audio rendering in the HMD device. It is to be understood that some common details of the aforementioned third aspect have already been described earlier with respect to the aforementioned first aspect, and have not been described again, for sake of brevity and avoiding repetition. Herein, the system comprises the HMD device and the at least one processor, wherein said HMD device comprises the at least one pose sensor and the audio processing unit. The at least one processor is communicably coupled to the HMD device, and optionally, to the at least one audio rendering device. The at least one processor controls an overall operation for the predictive spatial audio rendering in the HMD device of the aforementioned third aspect. Herein, the at least one processor is configured to receive the sensor data from the at least one pose sensor integrated into the HMD device. The at least one processor then processes the sensor data to determine the current pose of the HMD device at the first time instant. Next, the at least one processor is configured to process the sensor data obtained at the first time instant, which may include a position, an orientation, a velocity, an acceleration, and similar. In this regard, using predictive algorithms, for example, such as motion prediction models, machine learning techniques, kinematic estimation methods, and similar, the at least one processor is configured to generate the predicted pose data corresponding to the second time instant. This prediction accounts for ongoing motion patterns to estimate where the HMD device will be at the second time instant.

Next, the at least one processor is configured to receive the predicted pose data corresponding to the second time instant, which has been derived from the sensor data obtained at the first time instant. Based on the predicted pose data, the at least one processor may determine an anticipated auditory scene at the second time instant. In this regard, by applying spatial audio rendering techniques such as the Higher-Order Ambisonics, HRTFs, multi-channel audio formats, and similar, the at least one processor utilizes the predicted pose data, which represents the anticipated head orientation and position of the HMD device at the second time instant, to simulate perceived directionality and distance of the sound sources within the given space. In this context, the at least one processor is configured to generate spatial audio signals that correspond to the anticipated head pose, thereby pre-rendering the spatial audio data in advance for the second time instant. By mapping the predicted pose data to the spatial audio format, the at least one processor effectively encodes spatial characteristics of a given audio scene, including sound source positioning, spatial reflections, and room acoustics, from a perspective of the user's predicted head orientation. Optionally, the at least one processor is configured to pre-render the spatial audio data by calculating expected sound source positions relative to the predicted pose data; and generating spatial audio parameters based on the calculated sound source positions. The pre-rendered spatial audio data is then transmitted to the audio processing unit of the HMD device, allowing the system to handle rapid head movements with minimal latency. Optionally, prior to transmitting the spatial audio data to the audio processing unit, the at least one processor is further configured to encode the spatial audio data to the spatial audio format.

It will be appreciated that pre-rendering the spatial audio data based on the predicted pose data allows the system to accurately simulate the directionality and distance of the sound sources within the given space, thereby enhancing the user's immersive experience in VR/AR applications. It will also be appreciated that transmitting the pre-rendered spatial audio data to the audio processing unit of the HMD device prior to the actual head movement significantly reduces audio processing delays, thereby achieving seamless audio-visual synchronization.

Once the spatial audio data is transmitted to the audio processing unit, said audio processing unit is configured to obtain the latest pose data from the at least one pose sensor integrated into the HMD. Next, the audio processing unit compares the latest pose data with the predicted pose data that has been used when the spatial audio data has been initially pre-rendered. Herein, the pose difference may be calculated as a transformation matrix or a quaternion difference between the latest pose data (i.e., an actual head orientation of the user) and the predicted pose data (i.e., a predicted head orientation of the user). This difference may account for rotational deviations (i.e., a yaw, a pitch, roll changes and the like), translational shifts, and similar. The pose difference is then used to determine how much correction needs to be applied to the spatial audio data to maintain perceptual alignment. In this regard, the audio processing unit applies the rotational correction (as described earlier) to the spatial audio data to compensate for discrepancies between the latest pose data and the predicted pose data.

Next, the audio processing unit is configured to convert the spatial audio data from the spatial audio format to the binaural audio format. Specifically, the spatial audio data pre-rendered by the at least one processor corresponds to the predicted pose data of the HMD device at the second time instant. Upon receiving the spatial audio data, the audio processing unit may apply spatial audio rendering techniques (as mentioned earlier), to effectively convert the spatial audio data from the spatial audio format to the binaural audio format. In this regard, the audio processing unit may utilize HRTFs to model how sound waves interact with the user's head, ears, and torso, thereby replicating perceived directionality, distance, and depth of the sound sources in the given space. The binaural audio format is compatible with standard stereo headphones or in-ear monitors of the HMD device. It will be appreciated that converting the spatial audio data from the spatial audio format to the binaural audio format enables accurate reproduction of 3D audio cues, thereby allowing the user to perceive precise directionality and distance of the sound sources within the virtual environment.

Following the conversion, the audio processing unit is configured to transmit the spatial audio data in the binaural audio format to the at least one audio rendering device of the HMD device, for playback. In such a case, the audio processing unit transmits the binaural audio signals to the HMD's built-in speakers or external headphones for real-time audio output. It will also be appreciated that such transmission enables seamless audio delivery to both the built-in speakers of the HMD device and external headphones, thereby offering flexibility in audio output based on the user's preference and device compatibility.

Optionally, the audio processing unit is configured to process the spatial audio data in the binaural audio format for playback, without transmission. In this case, the audio processing unit directly handles audio playback within the HMD device without sending the audio signals to external audio devices. It will be appreciated that such an approach of processing reduces audio latency and ensures synchronized audio-visual perception during rapid head movements. It will also be appreciated that directly handling audio playback within the HMD device minimizes potential signal interference and ensures consistent audio quality, even in environments with limited connectivity. It will further be appreciated that this approach allows the system to efficiently manage audio resources and optimize power consumption, thereby enhancing overall performance of the HMD device.

Optionally, the at least one processor is further configured to:
generate a plurality of predicted pose data corresponding to different future time instants;
predictively render the spatial audio data for each of the plurality of predicted pose data; and
transmit each of the predictively rendered spatial audio data to the HMD device.

A technical effect of the aforementioned feature is that it enables seamless spatial audio synchronization by generating the plurality of predicted pose data and pre-rendering corresponding spatial audio data, thereby allowing instant selection of the most accurate audio frame based on the user's actual head pose, and effectively minimizing audio lag.

Optionally, the spatial audio format comprises at least one of: a first-order Ambisonics format, a higher-order Ambisonics format, a multi-channel audio format. A technical effect of the spatial audio format comprises at least one of: the first-order Ambisonics format, the higher-order Ambisonics format, the multi-channel audio format is that it enables flexible and optimized spatial audio encoding for different playback environments, ensuring immersive and perceptually accurate 3D audio experiences. By supporting multiple spatial audio formats, the system maintains high-quality spatial audio rendering across various device configurations while reducing computational overhead where necessary.

Optionally, the HMD device further comprises the at least one audio rendering device. A technical effect of the HMD device further comprising the at least one audio rendering device is that it allows for real-time, low-latency spatial audio playback that dynamically adapts to the user's head movements, thereby ensuring an enhanced immersive audio experience in XR environments.

Optionally, the at least one audio rendering device comprises at least one of: an integrated stereo speaker, a headphone, an audio headset. A technical effect of the at least one audio rendering device comprising at least one of: the integrated stereo speaker, the headphone, the audio headset is that it enables adaptable spatial audio rendering across different playback configurations, ensuring optimized spatial sound reproduction while maintaining perceptual consistency and synchronization with the user's anticipated head movements in various usage scenarios.

It is to be understood that some common details of the aforementioned optional features have already been described earlier, and have not been described again, for sake of brevity and avoiding repetition.

The present disclosure also relates to the aforementioned fourth aspect as described above. Various embodiments and variants disclosed above, with respect to the aforementioned third aspect, apply mutatis mutandis to the aforementioned fourth aspect.

In a fifth aspect, the present disclosure provides a system for spatial audio correction in a head-mounted display (HMD) device, the system comprising:

the HMD device comprising:
at least one pose sensor; and
an audio processing unit; and
at least one processor that is configured to:
   receive a spatial audio data in a spatial audio format; and
   transmit the spatial audio data to the audio processing unit,
      wherein the audio processing unit is configured to:
obtain latest pose data from the at least one pose sensor of the HMD device, wherein the latest pose data is indicative of a current pose of the HMD device at the second time instant;
apply a rotational correction to the spatial audio data, based on the latest pose data;
convert the spatial audio data from the spatial audio format to a binaural audio format; and
perform at least one of:
   transmitting the spatial audio data in the binaural audio format to at least one audio rendering device of the HMD device;
   processing the spatial audio data in the binaural audio format for playback, without transmission.

In a sixth aspect, the present disclosure provides a method for spatial audio correction in a head-mounted display (HMD) device, the method comprising:
receiving a spatial audio data in a spatial audio format;
transmitting the spatial audio data to an audio processing unit,
obtaining latest pose data from at least one pose sensor of the HMD device, wherein the latest pose data is indicative of a current pose of the HMD device at a second time instant;
apply a rotational correction to the spatial audio data, based on the latest pose data;
convert the spatial audio data from the spatial audio format to a binaural audio format; and
perform at least one of:
   transmitting the spatial audio data in the binaural audio format to at least one audio rendering device of the HMD device;
   processing the spatial audio data in the binaural audio format for playback, without transmission.

The present disclosure provides the aforementioned fifth aspect and the aforementioned sixth aspect for spatial audio correction in the HMD device. It will be appreciated that the system enables real-time spatial audio correction by dynamically aligning an audio output with the user's actual head movements. Beneficially, by obtaining the latest pose data at the second time instant, the system and the method ensures that the spatial audio data remains accurately synchronized with the user's orientation, mitigating discrepancies that may arise due to latency or sudden head movements. Moreover, applying the rotational correction based on the latest pose data enhances spatial audio accuracy, ensuring that perceived direction of sound sources remains consistent with the user's real-time perspective. This is particularly advantageous in immersive environments such in VR, AR, and similar, where even minor misalignment in the spatial audio data can disrupt the user perception and reduce realism. Furthermore, conversion of the spatial audio data from the spatial audio format to the binaural audio format at the audio processing unit ensures that spatial characteristics of sound field are preserved, enhancing perception of depth and directionality. The aforesaid system and the method enables real-time adaptation of the spatial audio data without relying on predictive modeling, making it particularly effective for scenarios where head movement of the user is unpredictable or highly variable. The system and the method are fast, robust, easy to implement, and facilitate accurate spatial audio correction by dynamically adjusting the audio output based on real-time head movement, thereby maintaining perceptual coherence in immersive environments. Notably, the fifth aspect ensures real-time correction of spatial audio playback based on latest head movements of the user, even in the absence of predictive rendering.

In the fifth aspect, the system is specifically designed to perform spatial audio correction in the HMD device. It is to be understood that some common details of the aforementioned fifth aspect have already been described earlier with respect to the aforementioned first aspect and/or the aforementioned third aspect, and have not been described again, for sake of brevity and avoiding repetition. Notably, the term “spatial audio correction” refers to a process of dynamically adjusting the spatial audio data based on a real-time head pose information of the HMD device, in order to correct perceived directionality and positioning of virtual sound sources within the given space. In VR/AR environments, the spatial audio rendering allows the user to perceive the sound from different directions and distances, corresponding to the position of the sound sources in the given space. However, when the user moves their head, the perceived audio direction should dynamically update in real time to match the user's head orientation. Without proper correction, audio lag or incorrect audio positioning can occur, leading to audio-visual desynchronization and breaking an immersive experience. Therefore, the purpose of the system is to perform the spatial audio correction based on real-time head pose of the HMD device, thereby ensuring accurate spatial audio perception.

Herein, the at least one processor controls an overall operation for spatial audio correction in the HMD device of the aforementioned fifth aspect. The at least one processor is configured to receive the spatial audio data in the spatial audio format from an external audio source or an audio generation module. The spatial audio data may represent multi-channel audio signals, such as Higher-Order Ambisonics, HRTF-based data, and similar, which encodes 3D positioning of the sound sources relative to the virtual environment. The received spatial audio data corresponds to an audio scene rendered for a particular head pose at a specific time instant. Upon receiving the spatial audio data, the at least one processor is configured to transmit the spatial audio data to the audio processing unit integrated into the HMD device. The transmission may occur via a wired communication interface or a wireless communication interface, depending on an architecture of the HMD device. It will be appreciated that by enabling the at least one processor to receive and transmit the spatial audio data to the audio processing unit, the system ensures a seamless data flow between the sound sources and the audio processing unit, thereby minimizing audio latency and enhancing spatial audio accuracy during head movement of the user.

Moreover, the spatial audio data transmitted to the audio processing unit is intended for further processing and correction based on real-time head pose data, which will be obtained from the at least one pose sensor of the HMD device. In this regard, the audio processing unit is configured to obtain the latest pose data from the at least one pose sensor integrated within the HMD device. The pose data reflects real-time head movements of the user, such as rotations, tilts, translational shifts, and similar, within the virtual environment. By obtaining the latest pose data, the audio processing unit can accurately track head orientation of the user and adjust audio scene accordingly. Next, the audio processing unit is configured to apply the rotational correction to the spatial audio data based on the latest pose data. The rotational correction may involve adjusting directionality of the sound sources in the spatial audio data to match the user's head orientation at the current time instant. For instance, if a user turns their head to left, the audio processing unit may rotate a virtual audio scene accordingly, so that the sound source remains perceptually fixed in a 3D environment. It will be appreciated that applying the rotational correction to the spatial audio data based on the latest pose data allows the spatial audio scene to be dynamically aligned with the current head orientation of the HMD device. This ensures that perceived directionality of the sound sources remains consistent with the user's visual experience in the virtual environment, thereby enhancing spatial audio accuracy and user immersion.

Next, the audio processing unit is configured to convert the spatial audio data from the spatial audio format to the binaural audio format. Following the conversion, the audio processing unit is configured to transmit the spatial audio data in the binaural audio format to the at least one audio rendering device of the HMD device, for playback. In such a case, the audio processing unit transmits the binaural audio signals to the HMD's built-in speakers or external headphones for real-time audio output. Optionally, the audio processing unit is configured to process the spatial audio data in the binaural audio format for playback, without transmission. In this case, the audio processing unit directly handles audio playback within the HMD device without sending the audio signals to external audio devices.

A technical effect of the aforementioned system is that an application of the rotational correction to the spatial audio data, based on the latest pose data, allows accurate realignment of the audio scene with the user's current head orientation. Such an approach ensures that perceived sound directionality remains consistent and realistic, thereby enhancing immersive spatial audio experience in the HMD device.

Optionally, the spatial audio format comprises at least one of: a first-order Ambisonics format, a higher-order Ambisonics format, a multi-channel audio format. A technical effect of the spatial audio format comprises at least one of: the first-order Ambisonics format, the higher-order Ambisonics format, the multi-channel audio format is that it enables flexible and optimized spatial audio encoding for different playback environments, ensuring immersive and perceptually accurate 3D audio experiences.

Optionally, the HMD device further comprises the at least one audio rendering device. A technical effect of the HMD device further comprising the at least one audio rendering device is that it allows for real-time, low-latency spatial audio playback that dynamically adapts to the user's head movements, thereby ensuring an enhanced immersive audio experience in XR environments.

Optionally, the at least one audio rendering device comprises at least one of: an integrated stereo speaker, a headphone, an audio headset. A technical effect of the at least one audio rendering device comprising at least one of: the integrated stereo speaker, the headphone, the audio headset is that it enables adaptable spatial audio rendering across different playback configurations, ensuring optimized spatial sound reproduction while maintaining perceptual consistency and synchronization with the user's anticipated head movements in various usage scenarios.

It is to be understood that some common details of the aforementioned optional features have already been described earlier, and have not been described again, for sake of brevity and avoiding repetition.

The present disclosure also relates to the aforementioned sixth aspect as described above. Various embodiments and variants disclosed above, with respect to the aforementioned fifth aspect, apply mutatis mutandis to the aforementioned sixth aspect.

### DETAILED DESCRIPTION OF THE DRAWINGS

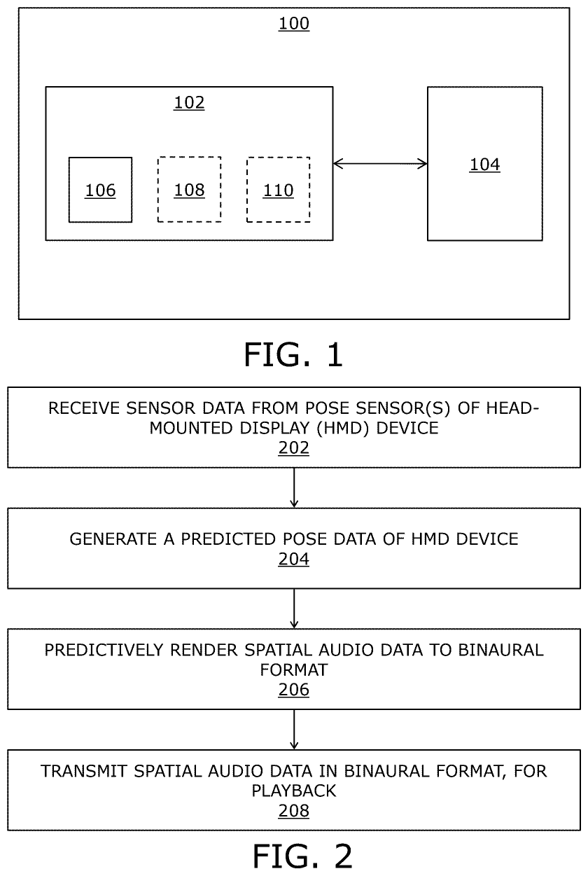

Referring to FIG. 1, illustrated is a block diagram of a system 100 for predictive spatial audio rendering, in accordance with a first aspect of the present disclosure. Herein, the system 100 comprises a head-mounted display (HMD) device 102 and at least one processor (depicted as a processor 104). The HMD device 102 comprises at least one pose sensor (depicted as a pose sensor 106). Herein, the processor 104 is communicably coupled to the HMD device 102. The processor 104 is configured to perform various operations, as described earlier with respect to the aforementioned first aspect. Optionally, the HMD device 102 comprises an audio processing unit 108. Optionally, the HMD device 102 further comprises at least one audio rendering device (depicted as an audio rendering device 110).

It may be understood by a person skilled in the art that the FIG. 1 includes a simplified architecture of a system 100 for sake of clarity, which should not unduly limit the scope of the claims herein. The person skilled in the art will recognize many variations, alternatives, and modifications of embodiments of the present disclosure.

Referring to FIG. 2, illustrated are steps of a method for predictive spatial audio rendering, in accordance with a second aspect of the present disclosure. At step 202, a sensor data is received from at least one pose sensor of a head-mounted display (HMD) device, wherein the sensor data is indicative of a current pose of the HMD device at a first time instant. At step 204, a predicted pose data of the HMD device is generated corresponding to a second time instant subsequent to the first time instant, based on the sensor data. At step 206, a spatial audio data is predictively rendered to a binaural audio format corresponding to the second time instant, for playback at at least one audio rendering device of the HMD device, based on the predicted pose data of the HMD device. At step 208, the spatial audio data is transmitted in the binaural audio format, for playback, to the at least one audio rendering device of the HMD device.

The aforementioned steps are only illustrative and other alternatives can also be provided where one or more steps are added, one or more steps are removed, or one or more steps are provided in a different sequence without departing from the scope of the claims herein.

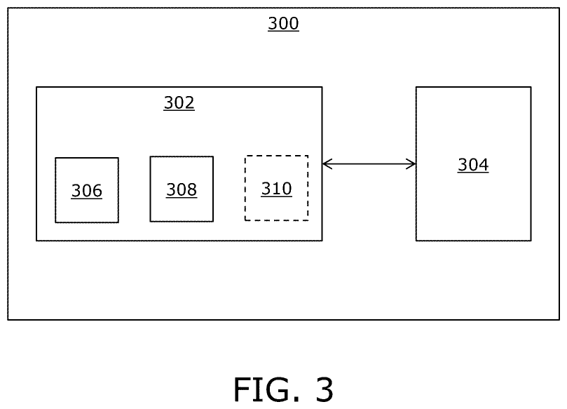

Referring to FIG. 3, illustrated is a block diagram of a system 300 for predictive spatial audio rendering in a head-mounted display (HMD) device 302, in accordance with a third aspect of the present disclosure. Herein, the system 300 comprises the HMD device 302 and at least one processor (depicted as a processor 304). The HMD device 302 comprises at least one pose sensor (depicted as a pose sensor 306) and an audio processing unit 308. Herein, the processor 304 is communicably coupled to the HMD device 302. The processor 304 is configured to perform various operations, as described earlier with respect to the aforementioned third aspect. Optionally, the HMD device 302 further comprises at least one audio rendering device (depicted as an audio rendering device 310).

It may be understood by a person skilled in the art that the FIG. 3 includes a simplified architecture of a system 300 for sake of clarity, which should not unduly limit the scope of the claims herein. The person skilled in the art will recognize many variations, alternatives, and modifications of embodiments of the present disclosure.

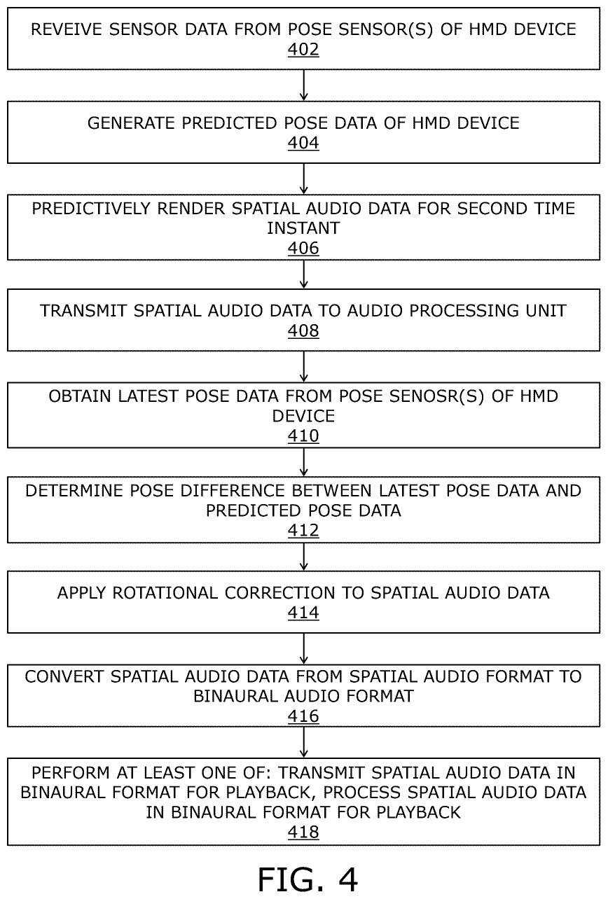

Referring to FIG. 4, illustrated are steps of a method for predictive spatial audio rendering in a head-mounted display (HMD) device, in accordance with a fourth aspect of the present disclosure. At step 402, a sensor data is received from at least one pose sensor of the HMD device, wherein the sensor data is indicative of a current pose of the HMD device at a first time instant. At step 404, a predicted pose data of the HMD device is generated corresponding to a second time instant subsequent to the first time instant, based on the sensor data. At step 406, a spatial audio data is predictively rendered for the second time instant to a spatial audio format corresponding to the second time instant, to the audio processing unit of the HMD device, based on the predicted pose data. At step 408, the spatial audio data is transmitted to an audio processing unit of the HMD device. At step 410, latest pose data is obtained from the at least one pose sensor of the HMD device, wherein the latest pose data is indicative of a current pose of the HMD device at the second time instant. At step 412, a pose difference is determined between the latest pose data and the predicted pose data. At step 414, a rotational correction is applied to the spatial audio data, based on the pose difference. At step 416, the spatial audio data is converted from the spatial audio format to a binaural audio format. At step 418, at least one of: transmitting the spatial audio data in the binaural audio format, for playback, to at least one audio rendering device of the HMD device; processing the spatial audio data in the binaural audio format for playback, without transmission is performed.

The aforementioned steps are only illustrative and other alternatives can also be provided where one or more steps are added, one or more steps are removed, or one or more steps are provided in a different sequence without departing from the scope of the claims herein.

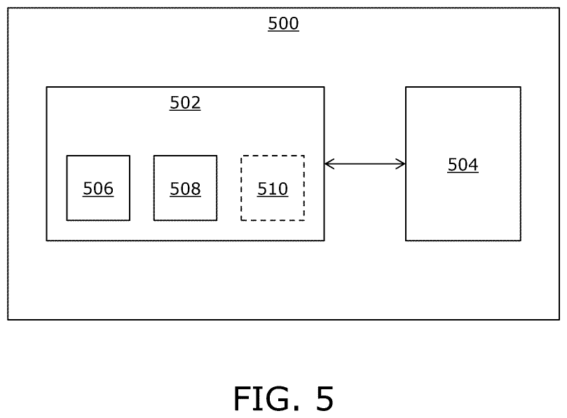

Referring to FIG. 5, illustrated is a block diagram of a system 500 for spatial audio correction in a head-mounted display (HMD) device 502, in accordance with a fifth aspect of the present disclosure. Herein, the system 500 comprises the HMD device 502 and at least one processor (depicted as a processor 504). The HMD device 502 comprises at least one pose sensor (depicted as a pose sensor 506) and an audio processing unit 508. Herein, the processor 504 is communicably coupled to the HMD device 502. The processor 504 is configured to perform various operations, as described earlier with respect to the aforementioned fifth aspect. Optionally, the HMD device 502 further comprises at least one audio rendering device (depicted as an audio rendering device 510).

It may be understood by a person skilled in the art that the FIG. 5 includes a simplified architecture of a system 500 for sake of clarity, which should not unduly limit the scope of the claims herein. The person skilled in the art will recognize many variations, alternatives, and modifications of embodiments of the present disclosure.

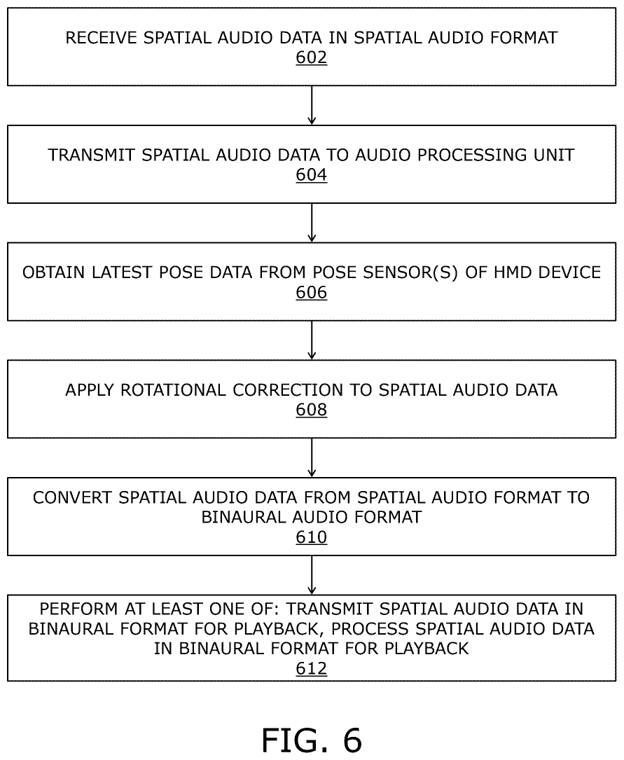

Referring to FIG. 6, illustrated are steps of a method for spatial audio correction in a head-mounted display (HMD) device, in accordance with a sixth aspect of the present disclosure. At step 602, a spatial audio data is received in a spatial audio format. At step 604, the spatial audio data is transmitted to an audio processing unit. At step 606, latest pose data is obtained from at least one pose sensor of the HMD device, wherein the latest pose data is indicative of a current pose of the HMD device at a second time instant. At step 608, a rotational correction is applied to the spatial audio data, based on the latest pose data. At step 610, the spatial audio data is converted from the spatial audio format to a binaural audio format. At step 612, at least one of: transmitting the spatial audio data in the binaural audio format to at least one audio rendering device of the HMD device; processing the spatial audio data in the binaural audio format for playback, without transmission is performed.

The aforementioned steps are only illustrative and other alternatives can also be provided where one or more steps are added, one or more steps are removed, or one or more steps are provided in a different sequence without departing from the scope of the claims herein.

1. A system for predictive spatial audio rendering, the system comprising:
a head-mounted display (HMD) device comprising at least one pose sensor; and
at least one processor configured to:
receive a sensor data from the at least one pose sensor of the HMD device, wherein the sensor data is indicative of a current pose of the HMD device at a first time instant;
generate a predicted pose data of the HMD device corresponding to a second time instant subsequent to the first time instant, based on the sensor data;
predictively render a spatial audio data to a binaural audio format corresponding to the second time instant, for playback at at least one audio rendering device of the HMD device, based on the predicted pose data of the HMD device; and
transmit the spatial audio data in the binaural audio format, for playback, to the at least one audio rendering device of the HMD device.

2. The system of claim 1, wherein the HMD device further comprises an audio processing unit, wherein when the spatial audio data is predictively rendered to a spatial audio format, the at least one processor is further configured to transmit the spatial audio data to the audio processing unit,
wherein the audio processing unit is configured to:
obtain the spatial audio data in the spatial audio format;
obtain latest pose data from the at least one pose sensor of the HMD device, wherein the latest pose data is indicative of a current pose of the HMD device at the second time instant;
determine a pose difference between the latest pose data and the predicted pose data;
apply a rotational correction to the spatial audio data, based on the pose difference, to generate a corrected spatial audio data;
render the corrected spatial audio data to the binaural audio format; and
transmit the spatial audio data in the binaural audio format, for playback, to the at least one audio rendering device of the HMD device.

3. The system of claim 1, wherein the at least one processor is further configured to:
generate a plurality of predicted pose data corresponding to different future time instants;
predictively render the spatial audio data for each of the plurality of predicted pose data; and
transmit each of the predictively rendered spatial audio data to the HMD device.

4. The system of claim 2, wherein the spatial audio format comprises at least one of: a first-order Ambisonics format, a higher-order Ambisonics format, a multi-channel audio format.

5. The system of claim 1, wherein the HMD device further comprises the at least one audio rendering device.

6. The system of claim 1, wherein the at least one audio rendering device comprises at least one of: an integrated stereo speaker, a headphone, an audio headset.

7. A method for predictive spatial audio rendering, the method comprising:
receiving a sensor data from at least one pose sensor of a head-mounted display (HMD) device, wherein the sensor data is indicative of a current pose of the HMD device at a first time instant;
generating a predicted pose data of the HMD device corresponding to a second time instant subsequent to the first time instant, based on the sensor data;
predictively rendering a spatial audio data to a binaural audio format corresponding to the second time instant, for playback at at least one audio rendering device of the HMD device, based on the predicted pose data of the HMD device; and
transmitting the spatial audio data in the binaural audio format, for playback, to the at least one audio rendering device of the HMD device.

8. A system for predictive spatial audio rendering in a head-mounted display (HMD) device, the system comprising:
the HMD device comprising:
at least one pose sensor; and
an audio processing unit; and
at least one processor that is configured to:
receive a sensor data from at least one pose sensor of the HMD device, wherein the sensor data is indicative of a current pose of the HMD device at a first time instant;
generate a predicted pose data of the HMD device corresponding to a second time instant subsequent to the first time instant, based on the sensor data;
predictively render a spatial audio data for the second time instant to a spatial audio format corresponding to the second time instant, to the audio processing unit of the HMD device, based on the predicted pose data; and
transmit the spatial audio data to the audio processing unit of the HMD device,
wherein the audio processing unit is configured to:
obtain latest pose data from the at least one pose sensor of the HMD device, wherein the latest pose data is indicative of a current pose of the HMD device at the second time instant;
determine a pose difference between the latest pose data and the predicted pose data;
apply a rotational correction to the spatial audio data, based on the pose difference;
convert the spatial audio data from the spatial audio format to a binaural audio format; and
perform at least one of:
transmitting the spatial audio data in the binaural audio format, for playback, to at least one audio rendering device of the HMD device;
processing the spatial audio data in the binaural audio format for playback, without transmission.

9. The system of claim 8, wherein the at least one processor is further configured to:
generate a plurality of predicted pose data corresponding to different future time instants;
predictively render the spatial audio data for each of the plurality of predicted pose data; and
transmit each of the predictively rendered spatial audio data to the HMD device.

10. The system of claim 8, wherein the spatial audio format comprises at least one of: a first-order Ambisonics format, a higher-order Ambisonics format, a multi-channel audio format.

11. The system of claim 8, wherein the HMD device further comprises the at least one audio rendering device.

12. The system of claim 8, wherein the at least one audio rendering device comprises at least one of: an integrated stereo speaker, a headphone, an audio headset.

13. A method for predictive spatial audio rendering in a head-mounted display (HMD) device, the method comprising:
receiving a sensor data from at least one pose sensor of the HMD device, wherein the sensor data is indicative of a current pose of the HMD device at a first time instant;
generating a predicted pose data of the HMD device corresponding to a second time instant subsequent to the first time instant, based on the sensor data;
predictively rendering a spatial audio data for the second time instant to a spatial audio format corresponding to the second time instant, to the audio processing unit of the HMD device, based on the predicted pose data; and
transmitting the spatial audio data to an audio processing unit of the HMD device,
obtaining latest pose data from the at least one pose sensor of the HMD device, wherein the latest pose data is indicative of a current pose of the HMD device at the second time instant;
determining a pose difference between the latest pose data and the predicted pose data;
applying a rotational correction to the spatial audio data, based on the pose difference;
converting the spatial audio data from the spatial audio format to a binaural audio format; and
performing at least one of:
transmitting the spatial audio data in the binaural audio format, for playback, to at least one audio rendering device of the HMD device;
processing the spatial audio data in the binaural audio format for playback, without transmission.

14. A system for spatial audio correction in a head-mounted display (HMD) device, the system comprising:
the HMD device comprising:
at least one pose sensor; and
an audio processing unit; and
at least one processor that is configured to:
receive a spatial audio data in a spatial audio format;
transmit the spatial audio data to the audio processing unit,
wherein the audio processing unit is configured to:
obtain latest pose data from the at least one pose sensor of the HMD device, wherein the latest pose data is indicative of a current pose of the HMD device at the second time instant;
apply a rotational correction to the spatial audio data, based on the latest pose data;
convert the spatial audio data from the spatial audio format to a binaural audio format; and
perform at least one of:
transmitting the spatial audio data in the binaural audio format to at least one audio rendering device of the HMD device;
processing the spatial audio data in the binaural audio format for playback, without transmission.

15. The system of claim 14, wherein the spatial audio format comprises at least one of: a first-order Ambisonics format, a higher-order Ambisonics format, a multi-channel audio format.

16. The system of claim 14, wherein the HMD device further comprises the at least one audio rendering device.

17. The system of claim 14, wherein the at least one audio rendering device comprises at least one of: an integrated stereo speaker, a headphone, an audio headset.

18. A method for spatial audio correction in a head-mounted display (HMD) device, the method comprising:
receiving a spatial audio data in a spatial audio format;
transmitting the spatial audio data to an audio processing unit,
obtaining latest pose data from at least one pose sensor of the HMD device, wherein the latest pose data is indicative of a current pose of the HMD device at a second time instant;
applying a rotational correction to the spatial audio data, based on the latest pose data;
converting the spatial audio data from the spatial audio format to a binaural audio format; and
performing at least one of:
transmitting the spatial audio data in the binaural audio format to at least one audio rendering device of the HMD device;
processing the spatial audio data in the binaural audio format for playback, without transmission.
